(19) United States
(12) Patent Application Publication
(10) Pub. No.: US 2009/0217216 A1
(43) Pub. Date: Aug. 27, 2009

(54) CARBON NANOTUBE CIRCUITS DESIGN METHODOLOGY

(75) Inventors: King F. Lee, Schaumburg, IL (US); Islamshah S. Amlani, Chandler, AZ (US)

Correspondence Address: INGRASSIA FISHER & LORENZ, P.C. (MOT), 7010 E. Cochise Road, SCOTTSDALE, AZ, 85253, US

(73) Assignee: Motorola, Inc., Schaumburg, IL (US)

(21) Appl. No.: 11/680,350

(22) Filed: Feb. 28, 2007

(51) Int. Cl. G06F 17/50

(52) U.S. Cl. 716/2; 977/742

(57) ABSTRACT

A methodology is provided for optimizing circuit parameters of circuits including carbon nanotube transistors. The method comprises mapping (122) selected transistor design parameters (118), based on carbon nanotube process parameters (120) and selected circuit topologies (114), into carbon nanotube physical attributes. A circuit layout is generated (124) from the carbon nanotube physical attributes and simulated (128). The steps are repeated until circuit specifications (130) are met. The carbon nanotube physical attributes may include, for example, the catalyst width (74) for growing a plurality of carbon nanotubes (72) or number of segments in a serpentine electrode structure (88, 89, 90) contacting a single carbon nanotube (81).

### FIELD OF THE INVENTION

The present invention generally relates to electronic circuitry and more particularly to a methodology for optimizing circuit parameters of circuits including carbon nanotube transistors.

### BACKGROUND OF THE INVENTION

One-dimensional nanostructures, such as belts, rods, tubes and wires, have become the focus of intensive research with their own unique applications. One-dimensional nanostructures are model systems to investigate the dependence of electrical and thermal transport or mechanical properties as a function of size reduction. In contrast with zero-dimensional, e.g., quantum dots, and two-dimensional nanostructures, e.g., GaAs/AlGaAs superlattice, direct synthesis and growth of one-dimensional nanostructures has been relatively slow due to difficulties associated with controlling the chemical composition, dimensions, and morphology. Alternatively, various one-dimensional nanostructures have been fabricated using a number of advanced nanolithographic techniques, such as electron-beam (e-beam), focused-ion-beam (FIB) writing, and scanning probe.

Carbon nanotubes (CNTs) are one of the most important species of one-dimensional nanostructures. Carbon nanotubes are one of four unique crystalline structures for carbon, the other three being diamond, graphite, and fullerene. In particular, carbon nanotubes refer to a helical tubular structure grown with a single wall (single-walled nanotubes) or multiple walls (multi-walled nanotubes). These types of structures are obtained by rolling a sheet formed of a plurality of hexagons. The sheet is formed by combining each carbon atom thereof with three neighboring carbon atoms to form a helical tube. Carbon nanotubes typically have a diameter on the order of a fraction of a nanometer to a few hundred nanometers. As used herein, a “carbon nanotube” is any elongated carbon structure.

Both carbon nanotubes and inorganic nanowires have been demonstrated as field effect transistors (FETs) and other basic components in nanoscale electronics such as p-n junctions, bipolar junction transistors, inverters, etc. The motivation behind the development of such nanoscale components is that “bottom-up” approach to nanoelectronics has the potential to go beyond the limits of the traditional “top-down” manufacturing techniques.

Unlike other inorganic one-dimensional nanostructures, carbon nanotubes can function as either a conductor, or a semiconductor, according to the chirality and the diameter of the helical tubes. With metallic-like nanotubes, a one-dimensional carbon-based structure can conduct a current at room temperature with essentially no resistance. Further, electrons can be considered as moving freely through the structure, so that metallic-like nanotubes can be used as ideal interconnects. When semiconductor nanotubes are connected to two metal electrodes, the structure can function as a field effect transistor wherein the nanotubes can be switched from a conducting to an insulating state by applying a voltage to a gate electrode. Therefore, carbon nanotubes are potential building blocks for nanoelectronic and sensor devices because of their unique structural, physical, and chemical properties.

In the case of carbon nanotubes, various catalytic material processes have been invoked even for a similar growth technique such as thermal chemical vapor deposition (CVD). For example, a slurry containing Fe/Mo or Fe nanoparticles served as a catalyst to selectively grow individual single walled nanotubes. However the catalytic nanoparticles usually are derived by a wet slurry route which typically has been difficult to use for patterning small features.

Another approach for fabricating nanotubes is to deposit metal films using ion beam sputtering to form catalytic nanoparticles. In an article by L. Delzeit, B. Chen, A. Cassell, R. Stevens, C. Nguyen and M. Meyyappan in Chem. Phys. Lett. 348, 368 (2002), CVD growth of single walled nanotubes at temperatures of 900° C. and above was described using Fe or an Fe/Mo bi-layer thin film supported with a thin aluminum under layer.

Ni has been used as one of the catalytic materials for the bulk formation of single walled nanotubes during laser ablation and arc discharge processes as described by Thess et al. in Science, 273, 483 (1996) and by Bethune et al. in Nature, 363, 605 (1993). Thin Ni layers have been widely used to produce multiwalled carbon nanotubes via CVD. The growth of single walled nanotubes using an ultrathin Ni/Al bilayer film as a catalyst in a thermal CVD process has been demonstrated. The Ni/Al film deposited by electron-beam evaporation allows for easier control of the thickness and uniformity of the catalyst materials (U.S. Pat. No. 6,764,874). When the substrate is heated, the Al layer melts and forms small droplets which absorb the residual oxygen inside the furnace and/or from the underlying SiO₂ layer and oxidize quickly to form thermally stable Al₂O₃ clusters. This in turn provides the support for the formation of Ni nanoparticles which catalyze the growth of single walled nanotubes. In addition to Ni, other catalysts that have been used to grow nanotubes include Fe and Co. In all cases, the catalyst region is lithographically patterned to define where the nanotubes will be grown.

One of the challenges faced in the fabrication of electronic devices utilizing carbon nanotubes is defining a process for growing the carbon nanotubes to provide a desired current output. Known carbon nanotube fabrication processes suffer due to a lack of flexible design parameters. For example, the drain current (strength) of a conventional MOSFET device is a function of the width and length of the channel. With carbon nanotube FETs, the channel is the carbon nanotube itself. The equivalent width of the channel is the diameter of the carbon nanotube. However, the width of the carbon nanotube may not be adjusted similarly to that of a typical MOSFET because the diameter of the carbon nanotube is often fixed for a particular carbon nanotube growth process. In addition, the diameter of the nanotube determines its bandgap, which affects the threshold voltage and contact resistance, thereby affecting the operation of the carbon nanotube FET. Multiple parallel carbon nanotube FETs, while possibly providing the necessary current output, requires an inefficient use of area on the integrated circuit.

Accordingly, it is desirable to provide a methodology for optimizing circuit parameters of circuits including carbon nanotube transistors. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A methodology is provided for optimizing circuit parameters of circuits including carbon nanotube transistors. The methodology comprises establishing circuit specifications, selecting one of a plurality of circuit topologies, selecting one of a plurality of transistor design parameters, and establishing carbon nanotube process parameters. The design parameters and process parameters are then mapped into carbon nanotube physical attributes. A circuit layout is generated and simulated based on carbon nanotube transistor models. If circuit specifications are not met and if all of the design parameters have not been simulated, different transistor design parameters are selected and the steps are repeated until circuit specifications are met. If all the design parameters have been exhausted, but if all the circuit topologies have not been selected and simulated, a different topology is selected and the steps are repeated until circuit specifications are met.

### BRIEF DESCRIPTION OF THE DRAWINGS

The present invention will hereinafter be described in conjunction with the following drawing figures, wherein like numerals denote like elements, and

FIG. 1 is a partial cross section of an exemplary embodiment;

FIG. 2 is a partial top view of the exemplary embodiment taken along line 2-2 of FIG. 1;

FIG. 3 is a top view of a four transistor inverter;

FIG. 4 is a top view of a two transistor inverter designed in accordance with an exemplary embodiment;

FIG. 5 is a top view of a four transistor inverter designed in accordance with the exemplary embodiment; and

FIG. 6 is a flow chart of the exemplary embodiment.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

One-dimensional nanostructures such as nanotubes and nanowires show promise for the development of molecular-scale transistors used in, e.g., resonators and logic/memory elements. One-dimensional nanostructures are herein defined as a material having a high aspect ratio of greater than 10 to 1 (length to diameter) and includes, either single or bundled, at least carbon nanotubes with a single wall or a limited number of walls, carbon nanofibers, carbon nanowires, and semiconducting nanowires.

A mapping process is described herein including three exemplary embodiments. The first exemplary embodiment comprises adjusting a width of the catalyst, or active region. The second exemplary embodiment comprises segmenting a single carbon nanotube with a serpentine gate structure having a determined number of segments. The third exemplary embodiment comprises a combination of the first two exemplary embodiments. The determination of catalyst width and number of carbon nanotube segments as a design parameter provides a flexible means for adjusting the strength, e.g., current output, of the device to meet circuit requirements.

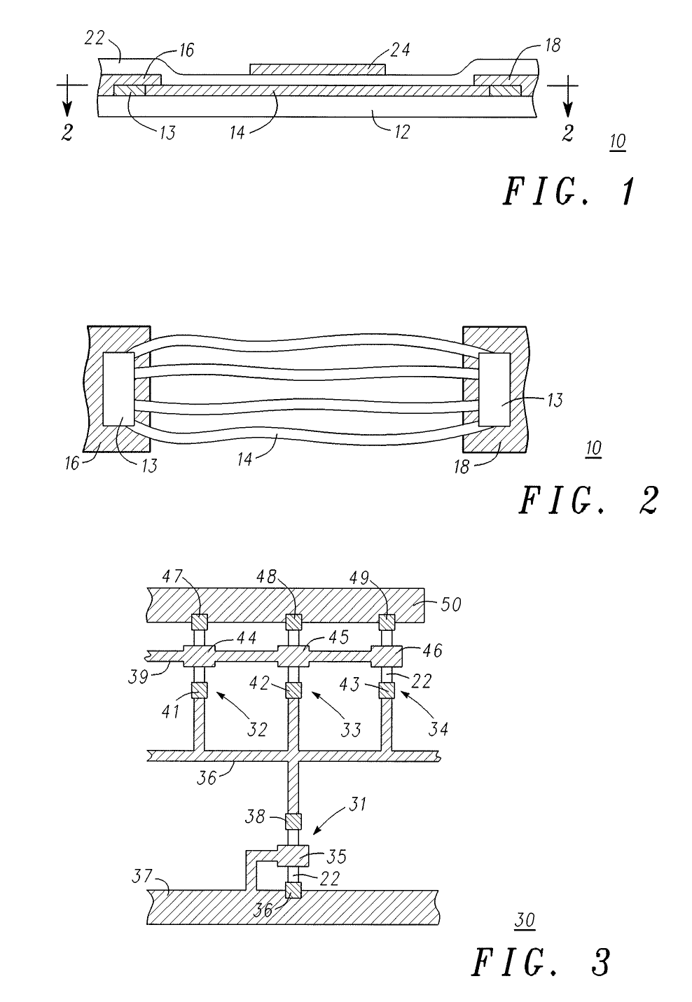

Referring to FIG. 1 which is a cross sectional view of the exemplary embodiment, and FIG. 2 which is taken along line 2-2 of FIG. 1, the structure 10 comprises a plurality of one-dimensional nanostructures 14 grown on a substrate 12. Though the described exemplary embodiment comprises a plurality of one-dimensional nanostructures 14, it is understood that only one one-dimensional nanostructure 14 is an alternative embodiment. The substrate 12 comprises preferably silicon dioxide; however, alternate materials, for example, glass, ceramic, metal, quartz, sapphire, a semiconductor material, or a flexible material is anticipated by this disclosure. Substrate 12 may also include control electronics or other circuitry (not shown). Also, substrate 12 may include an insulating layer, such as silicon dioxide, silicon nitride, quartz, or the like. One-dimensional nanostructures 14 are grown from the catalyst 13, preferably using CVD processes, and may comprise a single wall or a limited number of walls. The source electrode 16 and drain electrode 18 are formed to make contact with the one-dimensional nanostructures 14. The one-dimensional nanostructures 14 may comprise only a couple of one-dimensional nanostructures; however, since a single carbon nanotube 14 may suffer from device-to-device variation which limits the usability of the device, a plurality of carbon nanotubes 14 are positioned across the pair of electrodes 16 and 18 to minimize these issues. The nanotubes 14 are preferably grown using CVD processes, but may be grown in any manner known to those skilled in the art, and are typically 10 nm to 1 cm in length and less than 1 nm to 5 nm in diameter. Contact between the nanotubes 14 and electrodes 16 and 18 are made during fabrication, for example, by any type of lithography, e-beam, optical, soft lithography, or imprint technology. While the one-dimensional nanostructures 14 may comprise a mesh, it is preferred they comprise a plurality of one-dimensional nanostructures extending somewhat parallel between the source and drain electrodes without contacting adjacent one-dimensional nanostructures 14 (FIG. 2). Although some carbon nanotubes 14 may touch or even cross other carbon nanotubes 14, each carbon nanotube 14 will extend from source electrode 16 to drain electrode 18. The one-dimensional nanostructures 14 grow from the catalyst 13 before or after the source and drain electrodes 16 and 18 are formed. The catalyst 13 is deposited, or formed in any manner known in the art, with a width 15. The carbon nanotubes 14 are positioned below the electrodes 16 and 18 as shown, but alternatively some or all may be positioned above the electrodes 16 and 18. Lithographic masking and etching techniques may be used to remove the carbon nanotubes 14 not connected between source and drain electrodes 16 and 18.

The electrodes 16 and 18 preferably comprise Cr/Au, but may comprise any conducting material, for example, Al, Au, Ti/Au, Ti/Pd, and Pd. The electrodes 16 and 18 are preferably spaced between 10 nanometers and 1 millimeter apart. The thickness of the electrodes 16, 18 is generally between 0.01 and 100 micrometers, and would preferably be 1.0 micrometer.

A dielectric material 22 is formed by standard lithographic techniques, e.g., deposition, on the one-dimensional nanostructures 14 and a gate electrode 24 is formed thereover. Whether the gate electrode 24 overlaps the electrodes 16, 18 is a designer's choice.

FIG. 3 is a top view of an inverter 30 comprising four carbon nanotube transistors 31, 32, 33, 34, fabricated in a manner as shown for the structures 10 in FIGS. 1 and 2. While the present invention may be used with most types of electronic circuitry, the inverter has been chosen for its ease of presentation and understanding. Other types of electronic circuitry include, for example, logic gates, current mirrors, amplifiers, and oscillators. Transistor 31 has its gate 35 and drain 36 coupled to ground on conductor 37 and its source 38 coupled to the sources 41, 42, 43 of transistors 32, 33, 34 by conductive trace 36. Transistors 32, 33, 34 have their gates 44, 45, 46 coupled to a gate conductive trace 39 and their drains 47, 48, 49 coupled to a voltage on conductor 50. The transistor 31 serves as the pull-down device while the three transistors 32, 33, 34 together serve the pull-up function of the inverter. By fabricating the inverter 30 with three transistors 32, 33, 34, a larger pull-up output current (strength) is available than if only one transistor were used. However, this larger output is obtained by trading a large footprint, or area occupied on the integrated circuit, required by the three transistors 32, 33, 34.

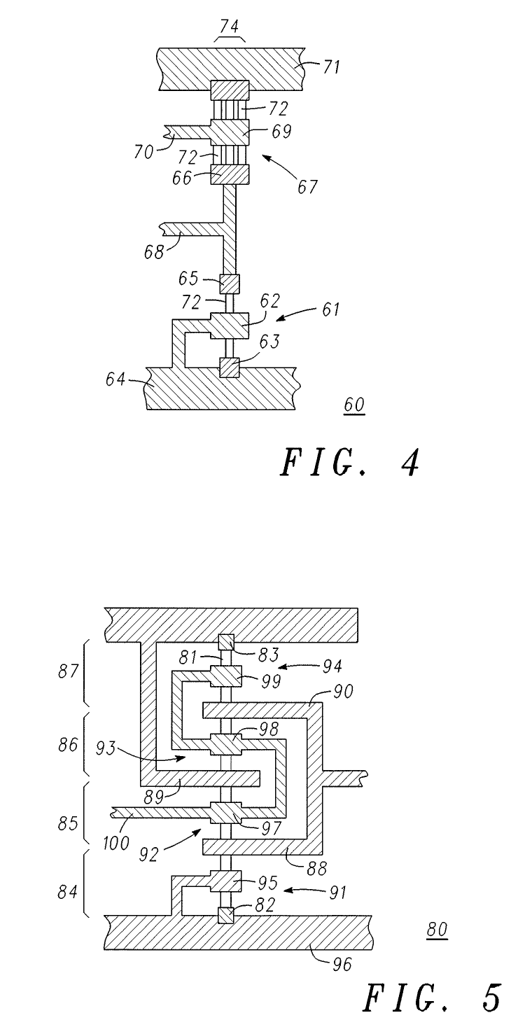

FIGS. 4 and 5 illustrate two approaches of obtaining the same current output as obtained by the three transistors 32, 33, 34 of FIG. 3, but with a reduced footprint (less area on the integrated circuit). The inverter 60 of FIG. 4 comprises a transistor 61 having its gate 62 and drain 63 coupled to ground on conductor 64 and its source 65 coupled to the source 66 of transistor 67 by conductive trace 68. Transistor 67 has its gate 69 coupled to a gate conductive trace 70 and its drain coupled to a voltage on conductor 71. The carbon nanotubes 72 are formed on the catalyst 73 as described in the text accompanying FIGS. 1 and 2.

The output current (strength) of transistor 67 is increased by making the width 74 of the catalyst 73 larger. A wider catalyst 73 area allows for a larger number of carbon nanotubes 72 to be grown; thereby increasing the current output. This increase in width 74 is accomplished by forming the catalyst 73 with a width 74 necessary to provide a current output of a magnitude to satisfy the desired circuit specifications. The process for determining this desired width follows. While the width of the catalyst 73 is discussed for this exemplary embodiment, other dimensions of the catalyst 73, such as thickness, or length may also be adjusted to obtain the desired current output. For example, the density of nanotube per unit width is affected by catalyst length.

The second approach of obtaining the same current output as obtained by the three transistors 32, 33, 34 of FIG. 3 for the inverter 80 as shown in FIG. 5 comprises a single carbon nanotube 81 grown between the electrodes 82 and 83. The carbon nanotube 81 may be grown in any known manner, but typically is grown from a catalyst nanoparticle (not shown) positioned on one of the electrodes 82 and 83. The carbon nanotube 81 is divided (in a serpentine pattern) into four segments 84, 85, 86, 87 by conductive traces 88, 89, 90. Each of the four segments 84, 85, 86, 87 define a transistor 91, 92, 93, 94, respectively. The transistor 91 has its gate 95 and drain 82 coupled to ground on conductor 96. The source of each of the transistors 91, 92, 93, 94 comprises the conductive trace 88, and the drain of each of the transistors 92, 93, 94 comprises the conductive trace 89. The gates 97, 98, 99 of the transistors 92, 93, 94 are coupled by the conductive trace 100. This arrangement of transistors 91, 92, 93, 94 accomplishes the same inverter function as the inverter shown in FIG. 3, however, it is accomplished with a single carbon nanotube 81. This provides the advantages of each transistor 92, 93, 94 having essentially identical electrical characteristic since their respective channels are formed on segments of the same carbon nanotube and thus having the same diameter, chirality, and electronic transport characteristic. Having essentially identical electrical characteristic among a plurality of transistors is especially advantageous to circuitry that can benefit from having well-matched transistors such as differential pairs and current mirrors.

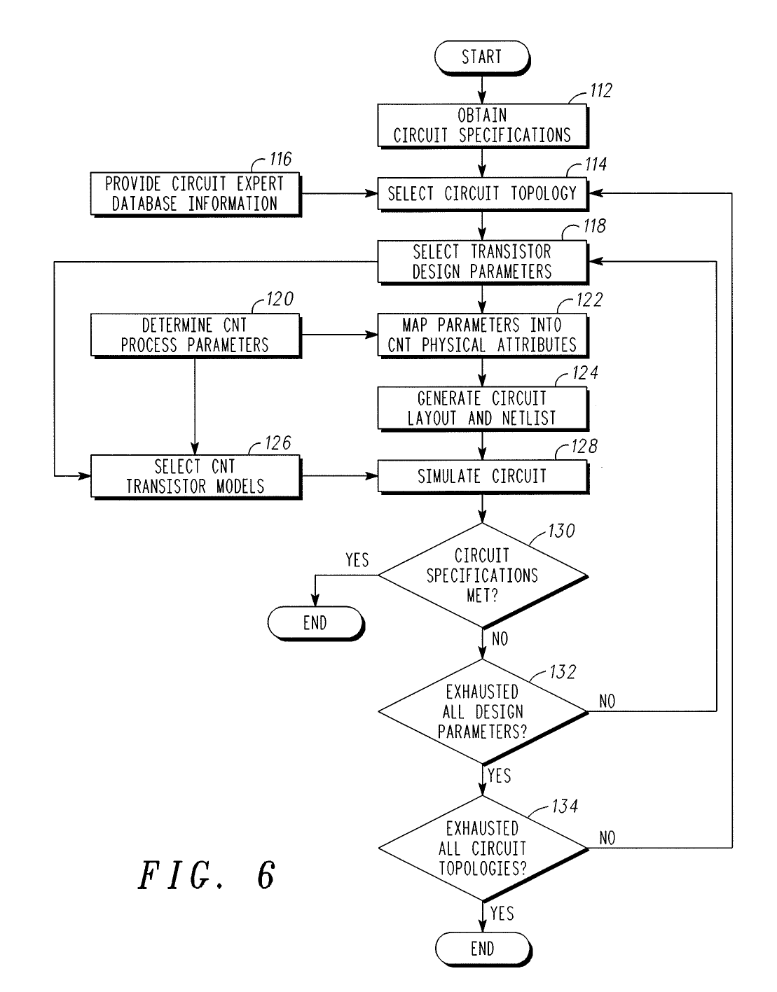

The process for determining the current output by determining the catalyst width 74 for the inverter 60 of FIG. 4 and by determining the number of segments 85, 86, 87 of inverter 80 of FIG. 5 is shown in the flow chart 110 of FIG. 6. Once the circuit specifications, including the required current output, are obtained 112, a circuit topology is selected 114. The circuit topology includes, for example, whether p-type, n-type, or complementary transistors will be used. The circuit expert database provides 116 the necessary topology information. The transistor design parameters are then selected 118. Transistor design parameters include, for example, transconductance, maximum drain current, impedance, on-state resistance, and saturation current of the transistor.

Carbon nanotube process parameters, such as carbon nanotube distribution density profile including the catalyst material, gasses used, time, temperature, and pressure of gasses during growth of the carbon nanotubes, are determined 120. The process parameters may also include equipment related parameters. Carbon nanotube physical attributes are mapped 122 from the transistor design parameters and carbon nanotube process parameters to form a trial physical design. For example, the physical width of the catalyst may be determined by a mapping function to the carbon nanotube distribution density profile and the transistor design parameter of maximum drain current as:

$${I}_{D} ∝ N \frac{{W}_{eff}}{L} = N \frac{f ( {W}_{CAT} , P )}{L} ,$$

where
I_{D}=maximum drain current,
N=number of segments,
ƒ=mapping function,
P=parameters of CNT growth process (CNT distribution density profile, CNT types . . . ),
W_{CAT}=width of the catalyst (or active) region, and
L=length of the channel.

A circuit layout and netlist are generated 124 from the physical attributes. Carbon nanotube transistor models are selected 126 from the transistor design parameters and the carbon nanotube process parameters. The circuit generated by the circuit layout and transistor models is then simulated 128. If the circuit specifications are not satisfied (130) by the simulation and all of the design parameters have not been considered (132), the process returns to step 118. If all of the design parameters have been considered (132), but all circuit topologies have not been considered (134), the process returns to step 114 until a circuit is designed that meets the circuit specifications.

A methodology has been described for determining the structure of a carbon nanotube channel of a field effect transistor. A carbon nanotube field effect transistor is provided having a desired current output with a minimum area occupied on the substrate.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method of designing an electronic device, comprising:
a) establishing circuit specifications;
b) selecting one of a plurality of circuit topologies;
c) selecting one of a plurality of transistor design parameters;
d) establishing carbon nanotube process parameters;
e) mapping transistor design parameters, based on the results of steps c) and d), into carbon nanotube physical attributes for the electronic device;
f) establishing carbon nanotube transistor models based on the results of steps c) and d);
g) simulating the electronic device based on the results of steps e) and f);
h) if circuit specifications of step a) are not met and if all of the design parameters of step c) have not been selected, return to step c); and
i) if all the design parameters have been exhausted, but if all the circuit topologies have not been selected, return to step b).

2. The method of claim 1 wherein step d) further comprises determining a carbon nanotube density profile including the time, temperature, and pressure of gasses during growth of the carbon nanotubes.

3. The method of claim 2 wherein the determining a carbon nanotube density profile further comprises determining the catalyst material composition and carbon nanotube growth steps.

4. The method of claim 1 wherein step e) comprises determining the dimension of a catalyst region for growing a plurality of carbon nanotubes.

5. The method of claim 1 wherein step e) comprises determining the number of segments of a single carbon nanotube defined by interdigitated source and drain electrodes.

6. The method of claim 1 wherein step e) comprises one of the steps selected from the group consisting of determining the dimension of a catalyst region for growing a plurality of carbon nanotubes thereon, and determining the number of segments across the plurality of carbon nanotubes defined by interdigitated source and drain electrodes.

7. The method of claim 1 wherein step e) comprises determining one of a plurality of carbon nanotube physical attributes from a mapping function in accordance to the equation
D∝A₁ƒ(A₂, P),
where
D=selected transistor design parameter,
ƒ=mapping function,
P=parameters of CNT growth process,
A₁=first carbon nanotube physical attribute, and
A₂=second carbon nanotube physical attribute.

8. The method of claim 7 wherein the first carbon nanotube physical attribute comprises the number of segments of a single carbon nanotube defined by interdigitated source and drain electrodes.

9. The method of claim 7 wherein the second carbon nanotube physical attribute comprises the dimension of a catalyst region for growing a plurality of carbon nanotubes.

10. The method of claim 7 wherein the selected transistor design parameter comprises one of transconductance, maximum drain current, on-state output impedance, off-state output impedance, input impedance, saturation current, noise figure, unity gain frequency, and maximum oscillation frequency.

11. A method for designing an electronic device, comprising:
determining the output current required for a carbon nanotube device including a plurality of carbon nanotubes;
determining the mapping density of the plurality of carbon nanotubes required to produce a desired output current; and
determining a catalyst dimension needed to provide the required output current based on the mapping density.

12. The method of claim 11 wherein the determining the mapping density comprises determining a carbon nanotube density profile including the time, temperature, and pressure of gasses during growth of the carbon nanotubes.

13. The method of claim 12 wherein the determining a carbon nanotube density profile further comprises determining the catalyst material composition and carbon nanotube growth steps.

14. The method of claim 11 further comprising determining one of a plurality of carbon nanotube physical attributes from a mapping function in accordance to the equation
D∝A₁ƒ(A₂, P),
where
D=selected transistor design parameter,
ƒ=mapping function,
P=parameters of CNT growth process,
A₁=first carbon nanotube physical attribute, and
A₂=second carbon nanotube physical attribute.

15. The method of claim 11 further comprising selecting a transistor design parameter including one of transconductance, maximum drain current, on-state output impedance, off-state output impedance, input impedance, saturation current, noise figure, unity gain frequency, and maximum oscillation frequency.

16. The method of claim 11 wherein the catalyst dimension comprises a width.

17. A method for designing an electronic device comprising a carbon nanotube having a plurality of segments defined by interdigitated source and drain electrodes coupled to the carbon nanotube, and one each of a plurality of gate electrodes coupled to each of the segments, comprising:
determining the output current required for a carbon nanotube device comprising the carbon nanotube; and
determining the number of interdigitated source and drain electrodes required to produce a required output current for the electronic device.

18. The method of claim 17 further comprising determining a carbon nanotube profile for growth of the carbon nanotube including the time, temperature, and pressure of gasses during growth.

19. The method of claim 18 wherein the determining a carbon nanotube profile further comprises determining the catalyst material composition and carbon nanotube growth steps.

20. The method of claim 17 further comprising determining one of a plurality of carbon nanotube physical attributes from a mapping function in accordance to the equation
D∝A₁ƒ(A₂, P),
where
D=selected transistor design parameter,
ƒ=mapping function, and
P=parameters of CNT growth process,
A₁=first carbon nanotube physical attribute, and
A₂=second carbon nanotube physical attribute.

21. The method of claim 17 further comprising selecting a transistor design parameter including one of transconductance, maximum drain current, on-state output impedance, off-state output impedance, input impedance, saturation current, noise figure, unity gain frequency, and maximum oscillation frequency.
